(19) United States
(12) Patent Application Publication
(10) Pub. No.: US 2026/0280674 A1
(43) Pub. Date: Sep. 17, 2026

(54) BEAM REPORT AND UE CAPABILITY CONFIGURATION FOR AI/ML-BASED BEAM MANAGEMENT

(71) Applicant: MEDIATEK INC., Hsinchu City (TW)

(72) Inventors: Yu-Jen KU, San Jose, CA (US); Gyu Bum KYUNG, San Jose, CA (US)

(73) Assignee: MEDIATEK INC., Hsinchu City (TW)

(21) Appl. No.: 19/472,820

(22) PCT Filed: Jul. 26, 2024
(86) PCT No.: PCT/CN2024/107725

§ 371 Date: Oct. 6, 2025

Related U.S. Application Data
(60) Provisional application No. 63/516,177, filed on Jul. 28, 2023.
(60) Provisional application No. 63/517,620, filed on Aug. 4, 2023.

(51) Int. Cl. H04B 7/06; H04L 41/16; H04W 8/22; H04W 24/10

(52) U.S. Cl. CPC H04B 7/0696; H04L 41/16; H04W 8/22; H04W 24/10

(57) ABSTRACT

In an aspect of the disclosure, a method, a computer-readable medium, and an apparatus are provided. The apparatus may be a UE. The UE receives a beam report configuration for artificial intelligence/machine learning (AI/ML) based beam management from a base station, wherein the beam report configuration comprises a configuration parameter set enabling reporting for the AI/ML based beam management. The UE determines a beam set that meets a predetermined performance metric based on the beam report configuration. The UE reports the beam set to the base station.

### CROSS-REFERENCE TO RELATED APPLICATION(S)

This application claims the benefits of U.S. Provisional Application Ser. No. 63/516,177, entitled “METHOD AND APPARATUS OF BEAM REPORT CONFIGURATION FOR AI/ML-BASED BEAM MANAGEMENT” and filed on Jul. 28, 2023, and U.S. Provisional Application Ser. No. 63/517,620, entitled “METHOD AND APPARATUS OF UE CAPABILITY REPORT ON BEAM REPORTING FOR AI/ML-BASED BEAM” and filed on Aug. 4, 2023, both of which are expressly incorporated by reference herein in their entirety.

### BACKGROUND

### Field

The present disclosure relates generally to wireless communications, and more particularly, to techniques of beam reporting for artificial intelligence/machine learning (AI/ML) based beam management in wireless communication systems.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE receives a beam report configuration for artificial intelligence/machine learning (AI/ML) based beam management from a base station, wherein the beam report configuration comprises a configuration parameter set enabling reporting for the AI/ML based beam management. The UE determines a beam set that meets a predetermined performance metric based on the beam report configuration. The UE reports the beam set to the base station.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7(A) is a diagram illustrating an AI/ML (artificial intelligence/machine learning) model for spatial and temporal domain beam prediction.

FIG. 7(B) is a diagram illustrating the temporal aspects of beam measurement and prediction in AI/ML-based beam management.

FIG. 8(A) illustrates a flow chart 800 of a process for beam reporting in an AI/ML-based beam management system.

FIG. 8(B) presents a flow chart 830 that outlines another process for beam reporting, with an additional step focusing on UE capability reporting.

FIG. 8(C) presents a flow chart 850 that outlines a further process for beam reporting, also with an additional step focusing on UE capability reporting.

FIG. 9 illustrates a diagram depicting a CSI report configuration structure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

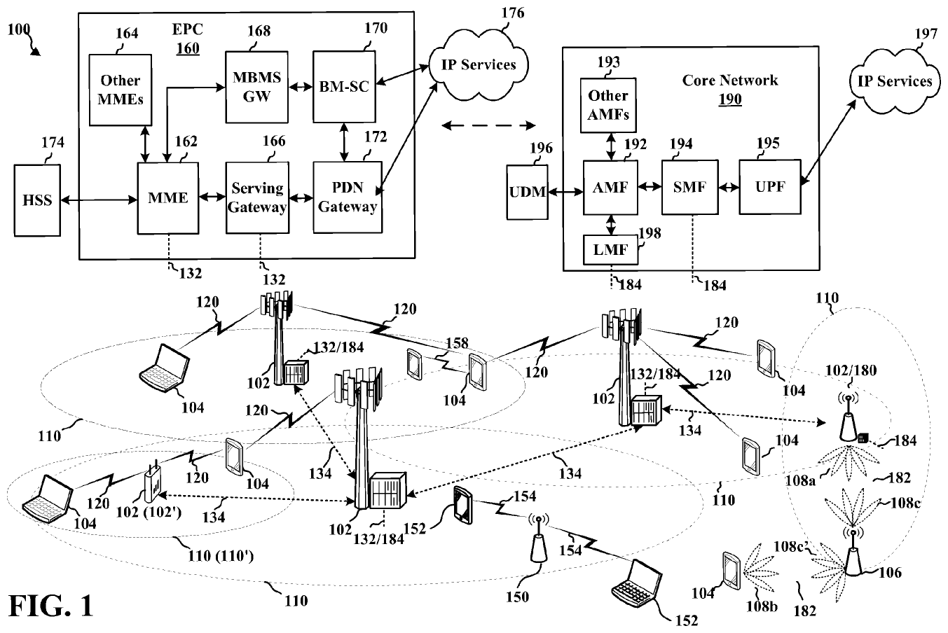

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mm W frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

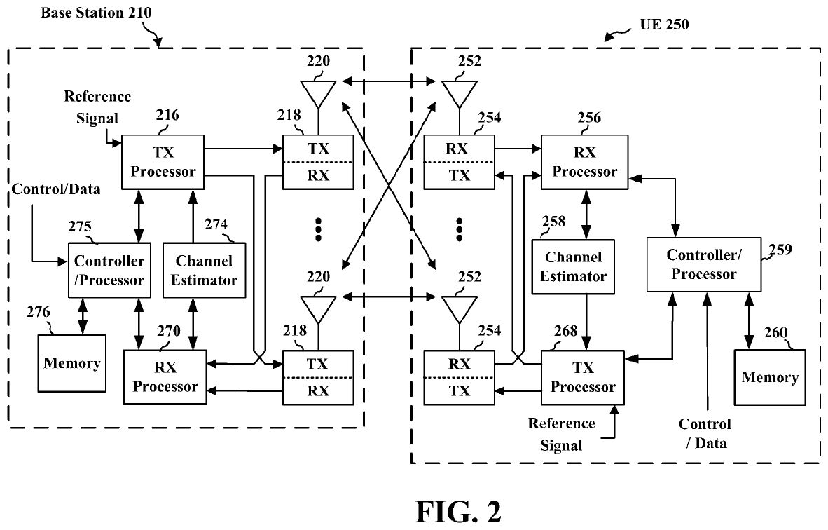

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

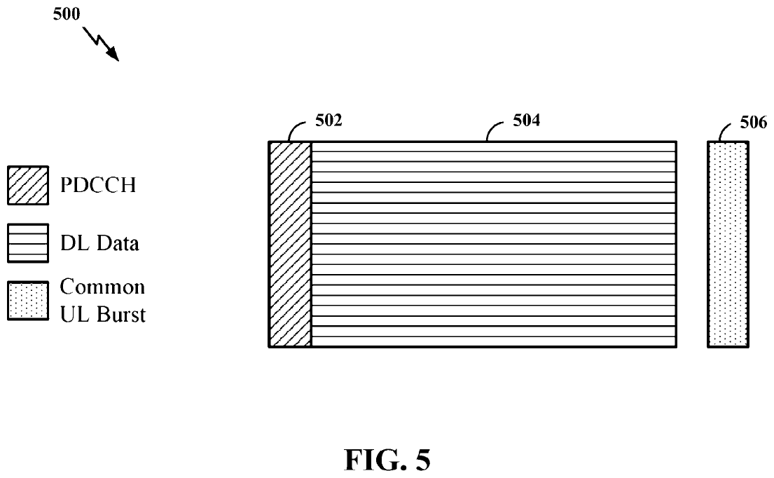

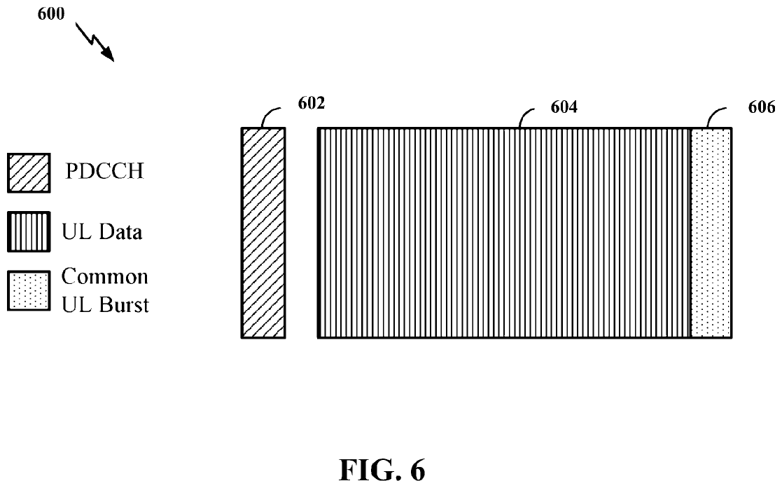

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

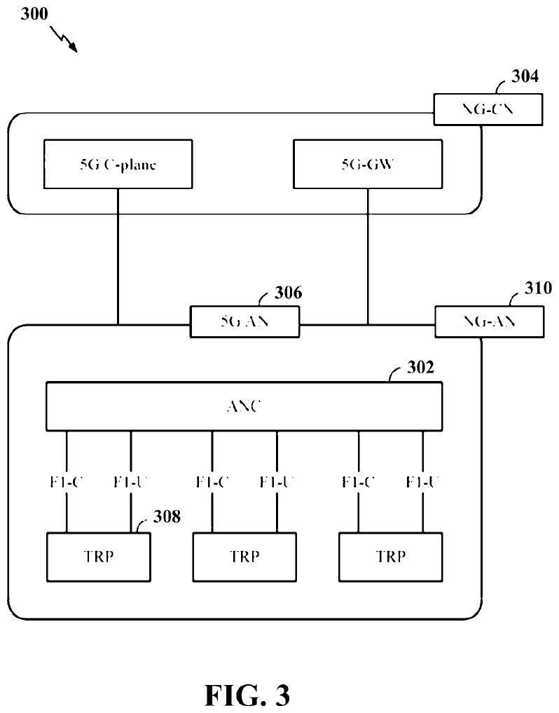

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

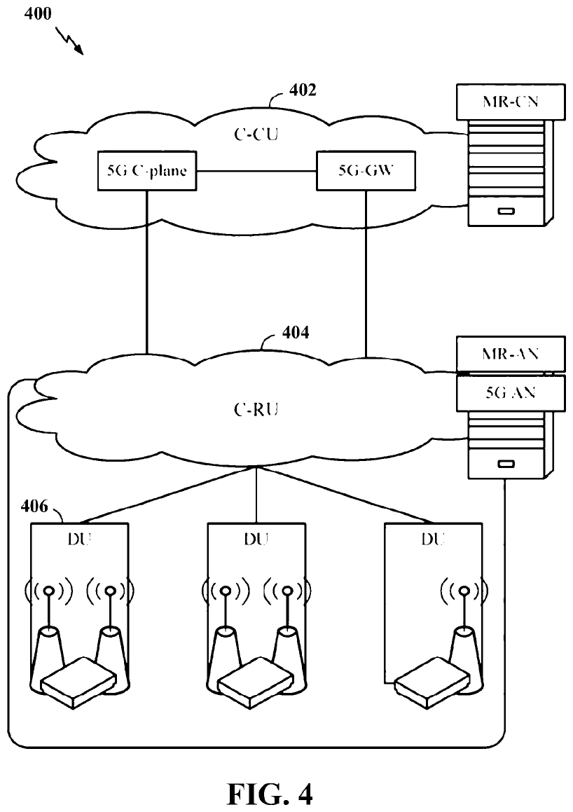

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

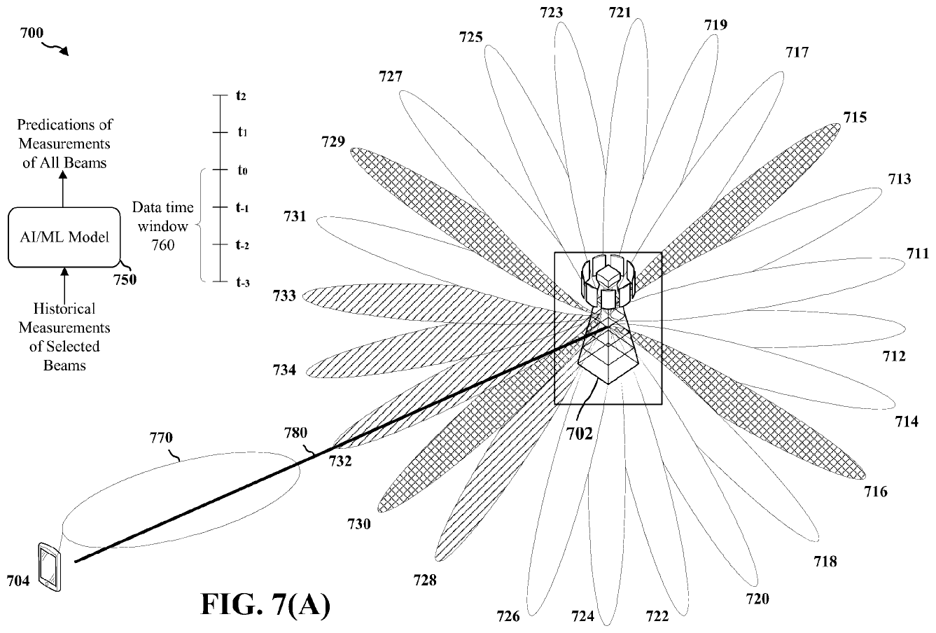

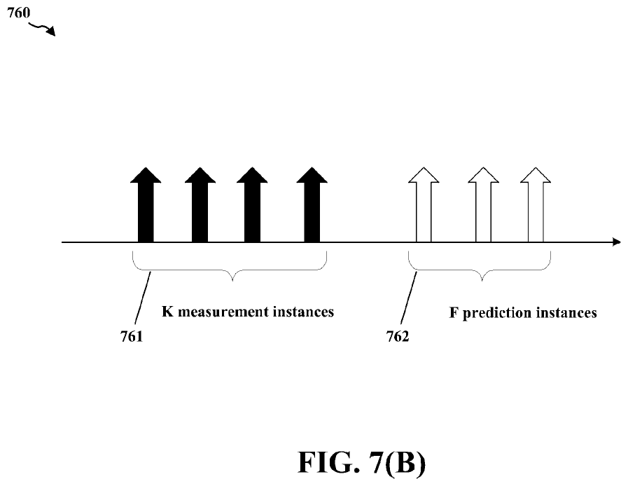

FIG. 7(A) is a diagram 700 illustrating an AI/ML (artificial intelligence/machine learning) model for spatial and temporal domain beam prediction. In this example, the base station 702 simultaneously transmits beams 711-734 in various directions via channel 780. After identifying incoming beams, the UE 704 can compute Layer 1 Reference Signal Received Power (L1-RSRP) for each beam. L1-RSRP is the average received power of the resource elements that carry the secondary synchronization signals or channel state information reference signals (CSI-RS).

Machine learning algorithms are used to analyze the history of signal strengths from a subset of beams and attempt to find patterns or trends in the data. This helps predict the signal strengths of the remaining unmeasured beams. By identifying patterns in historical data from the subset of beams, the algorithm can predict signal strengths of the other beams even as the UE is moving.

In this example, the base station 702 is equipped with multiple antennas and is capable of simultaneously radiating 24 different beams 711-734 in various directions. The UE 704, which moves from time to time, may be equipped with its own antenna and periodically measures channel indicators such as RSRP from 4 beams (e.g. beams 715, 716, 729, and 730) selected from the 24 beams radiated by the base station 702. The set of beams (e.g. beams 715, 716, 729, and 730) measured as AI/ML input (sensing beams) is referred to as beam Set B. The set of beams (e.g. the 24 beams) that is being predicted as AI/ML output (usually communication beams) is referred to as beam Set A.

The measurements collected from these 4 beams are saved over time as historical data. The historical data captures how the channel indicators for the subset of beams change over time, capturing how the UE 704 interacts with those beams. The UE 704 may be configured with a historical data time window 760 during which measurements are stored in the UE 704. In this example, the current time is t₀. The historical data time window 760 spans from time t₋₃ to t₀. Measurement data for the subset of beams 715, 716, 729, and 730 obtained during the historical data time window 760 are stored in the UE 704 and used as input to the AI/ML model 750 to predict measurements of unmeasured beams at the current time t₀ as well as measurements of all the beams at future times t₁, t₂.

The historical data serves as input to a machine learning algorithm to predict channel indicators for unmeasured beams, guiding the UE 704 on which beams to focus when it needs to communicate with the base station 702. The algorithm can thus predict channel indicators for all beams based on analyzing patterns and trends in the historical data from the subset of beams.

Another set of beams (e.g. beams 711, 721, 724, and 734) that are not normally measured under regular circumstances can be sampled periodically and their channel indicators recorded. This can be used to validate if the algorithm's predictions match actual performance while also updating the AI/ML model. Periodic measurements help improve the algorithm by updating its weights and parameters. As the machine learning algorithm matures, its predictions of the best beams will become increasingly accurate. When the UE 704 initiates communication, it can select the UE transmit or receive beam 770 that is likely to yield superior signal quality (e.g. the best beam) based on the prediction.

Rather than identifying a single best beam, the method predicts the top-k beams that are likely to have the highest channel indicators. In many cases, focusing on the top-k beams can provide excellent accuracy. The top-k beam prediction is achieved by estimating them based on the top-k channel indicator values. This aligns very well with real-world communication needs, improving system performance.

The main output of a classification-based AI/ML model includes identifiers (IDs) of the predicted top-k best beams for communication, along with corresponding predicted confidence scores or predicted RSRP for each beam. These beams are determined to be most suitable for communication based on expected signal strength and reliability. For example, if k is set to 5, the model might predict that the five best communication beams in the entire beam set are the beams numbered 732, 730, 734, 728, and 733. This prediction enables the UE 704 to make an informed decision on which beams the base station 702 and UE 704 should use to communicate at any given time, optimizing performance based on signal strength and likelihood of successfully transmitting data.

Furthermore, the output of a regression-based AI/ML model includes predicted RSRP values for each communication beam in beam Set A. This predicted output directly estimates the expected signal strength of each individual beam in the communication set, allowing the UE 704 to select beams more granularly based on the predicted RSRP values.

Beamforming, a technique for enhancing data rates and reliability in 5G and beyond wireless communication, especially in millimeter wave (mmWave) frequencies, enables a base station, such as the base station 702, to focus its signal transmission and reception toward a specific user equipment (UE), such as the UE 704. This targeted approach improves signal quality and reduces interference. To establish an optimal beam connection, the base station 702 and the UE 704 need to identify the best beams to transmit and receive data, a process known as beam management. Traditional beam management often involves exhaustive beam sweeping, where the base station 702 and the UE 704 systematically scan through all available beam directions to find the best one. However, this method becomes inefficient and resource-intensive as the number of antennas and beams increases, leading to significant overhead.

AI/ML-based beam management, in contrast, offers a more agile and efficient alternative to exhaustive beam sweeping. By using the power of machine learning, this approach predicts the optimal beams for communication based on analyzing patterns in historical data obtained from a subset of beams.

As illustrated in FIG. 7(A), rather than measuring all 24 beams, the UE 704 selectively measures the L1-RSRP from a smaller subset of beams, denoted as beam Set B, which serves as input to an AI/ML model 750. By analyzing patterns and trends in the historical data from this subset of beams, the AI/ML model 750 predicts the L1-RSRP values for the remaining unmeasured beams in beam Set A.

The AI/ML model 750 may take various forms, such as classification-based or regression-based models. A classification model predicts the top-k best beams for communication and provides associated confidence scores. A regression model directly estimates the RSRP values for each communication beam in beam Set A. Regardless of the chosen model, this predictive capability significantly reduces the need for exhaustive measurements, minimizing overhead and enhancing efficiency.

Temporal beam prediction, a key aspect of AI/ML-based beam management, predicts future optimal beam indices based on historical beam measurements. The UE 704 uses measurements taken over a historical data time window 760, allowing the model 750 to learn temporal patterns and anticipate future beam conditions.

In essence, AI/ML-based beam management provides a faster and more efficient way to obtain the best beam information, optimizing beam selection for communication between a base station and a UE, especially in dynamic environments where beam conditions may change rapidly.

FIG. 7(B) is a diagram 760 illustrating the temporal aspects of beam measurement and prediction in AI/ML-based beam management. The figure shows two sequences: a measurement sequence 761 and a prediction sequence 762.

The measurement sequence 761 represents K measurement instances, where the UE 704 conducts beam measurements. These measurements are typically performed on a subset of beams (e.g., beam Set B), which serves as input to the AI/ML model. These measurements provide the power measurements of the sensing beams, which are used to infer the optimal communication beams.

The prediction sequence 762 represents F prediction instances, where the AI/ML model predicts the future optimal beam indices. These predictions are based on the beam measurements from the previous time steps, specifically the measurements taken during the K measurement instances.

This temporal structure aligns with the concept of temporal beam prediction, where the goal is to predict future optimal beam indices using the beam measurements on the sensing beams from previous time steps. The RSRP of one or more beams can be predicted with an input of historical RSRPs.

That is, the measurement sequence 761 corresponds to the time instances for which the UE 704 reports actual measurements. The prediction sequence 762 represents the future time instances for which the AI/ML model (either at the UE 704 or the base station 702) predicts beam conditions.

In advanced wireless communication systems, such as 5G and beyond, beamforming may enhance data rates and reliability, particularly in millimeter wave (mmWave) frequencies. The base station 702 and the UE 704 need to identify the optimal beams for communication, a process known as beam management. Traditional beam management often involves exhaustive beam sweeping, which becomes inefficient as the number of available beams increases. To address this challenge, AI/ML-based beam management has been proposed as a more efficient alternative.

AI/ML-based beam management requires new reporting configurations to accommodate various scenarios and purposes of beam reporting. The reporting format used to carry the reported beam measurement results can differ based on the location of the AI/ML model (either at the network side or the UE side) and the specific requirements of the beam management task.

When the AI/ML model is located at the network side (e.g., the base station 702), the UE 704 needs to be configured to report measurements of beams in Set B. The methods for reporting these measurements may vary depending on the specific AI/ML model design. For temporal beam prediction, the UE 704 may need to include a temporal ID in the report to indicate the time of measurement.

Conversely, when the AI/ML model is located at the UE side, the UE 704 needs to be configured to report the inferred best beams among the communication beams. In this case, the UE 704 may report a variable number of predicted best beams according to the AI/ML model output design. This number is not known beforehand by the network, necessitating a new reporting format for measurements. Similar to the network-side model case, temporal beam prediction may require the inclusion of a temporal ID in the report.

For data collection purposes at the network side, the UE 704 needs to be configured to report measurements of a set of beams, which may include Set A, Set B, a union of Set A and Set B, or other combinations. The UE 704 may report a variable number of measured best beams as labels (according to the AI/ML model output design), which needs to be configured by the network. Additionally, the UE 704 may report a variable number of measured beams (according to the AI/ML model input design), which may or may not be known beforehand by the network.

To accommodate these various scenarios and requirements, new Radio Resource Control (RRC) parameters need to be created in the CSI report configuration. These parameters will allow the network to differentiate between the different cases and enable the UE 704 to send the measurement report with the appropriate beam report format.

To address the challenges of traditional beam management and utilize the advantages of AI/ML-based approaches, new Radio Resource Control (RRC) parameters may be introduced in the report configuration. These parameters aim to enable efficient beam reporting for AI/ML-based beam management, accommodating various scenarios and purposes.

The new configuration parameter set in the report configuration may include several elements. Firstly, mode parameters indicate the AI Beam Management (BM) modes, such as spatial (BM Case1) and temporal beam prediction (BM Case2). For temporal beam prediction, additional temporal information needs to be incorporated into the beam report. This may include parameters indicating the prediction time instances periodicity, the number of prediction time instances, and the number of observation time instances.

Secondly, receiving (Rx) usage type parameters specify the measurement Rx type. These parameters are particularly useful for network-side models, as they rely on the UE 704 to provide accurate beam measurements as input. Different AI/ML models may be trained with varying assumptions about how the UE 704 measures RSRP/SINR. These assumptions could involve using all available Rx beams, specific Rx beams, or quasi-optimal Rx beams for formulating the AI/ML model input. Examples of quasi-optimal Rx beams might include the previously used Rx beam or the Rx beam obtained by UE Rx beam sweeping on specific Tx beams.

The Rx usage type parameters aim to address potential measurement issues that could affect the accuracy of the AI/ML model's predictions. Two scenarios that may lead to poor L1 RSRP measurements are: (1) when the UE 704 selects an Rx beam pointing in a suboptimal direction, resulting in inaccurate measurements, and (2) when the UE 704 is far from the base station 702, even with a good beam direction, measurements may be poor. While the AI/ML model can handle the second scenario through training, the Rx usage type parameters help mitigate the first scenario by guiding the UE 704 to select the optimal Rx beam direction.

Thirdly, model output parameters indicate that a report is for inferred AI/ML model output reporting from the UE-side model. These parameters may include sub-parameters specifying the number of inferred beams to report. This allows the network to configure the UE 704 to report a specific number of top predicted beams based on the UE-side AI/ML model's output.

Fourthly, model input parameters indicate that a report is for AI/ML model input for the network-side model. These parameters may include sub-parameters specifying the reporting format, which can vary according to the AI/ML model's input design. This flexibility allows the network to configure the UE 704 to report measurements in a format that aligns with the requirements of the network-side AI/ML model.

Fifthly, data collection parameters indicate that a report is for data collection purposes, which is useful for AI/ML model training. These parameters may include sub-parameters specifying the reporting format (according to the AI/ML model input design) and the label size. The network can also indicate whether to include the label in the report, based on the AI/ML model's output design. For data collection, the UE 704 needs to report both the model input (beam measurements) and the ground truth (actual best beams), allowing the AI/ML model to learn from real-world data.

Lastly, model monitoring parameters indicate that a report is for model monitoring purposes. These parameters can be used to specify various monitoring report purposes, such as reporting an event, reporting a monitoring performance metric, or reporting beam measurements of a specific set of beams. This allows the network to monitor the performance and accuracy of the AI/ML-based beam management system over time.

By introducing these new RRC parameters, the report configuration can be tailored to support various AI/ML-based beam management scenarios. This approach allows for more efficient and flexible beam reporting, enabling the system to leverage the power of AI/ML techniques while minimizing overhead and maximizing performance in 5G and beyond wireless communication systems.

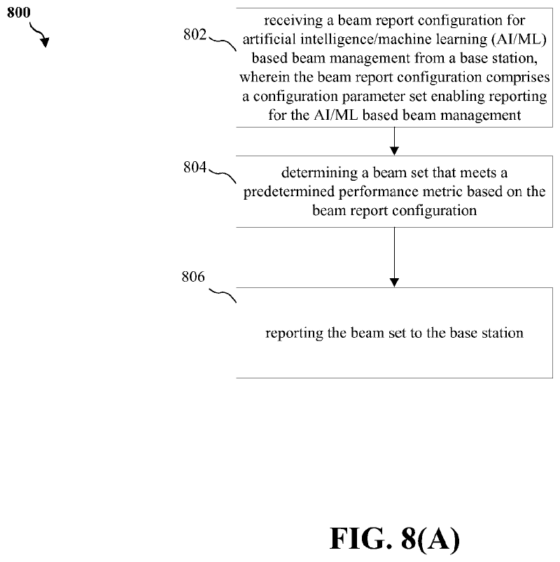

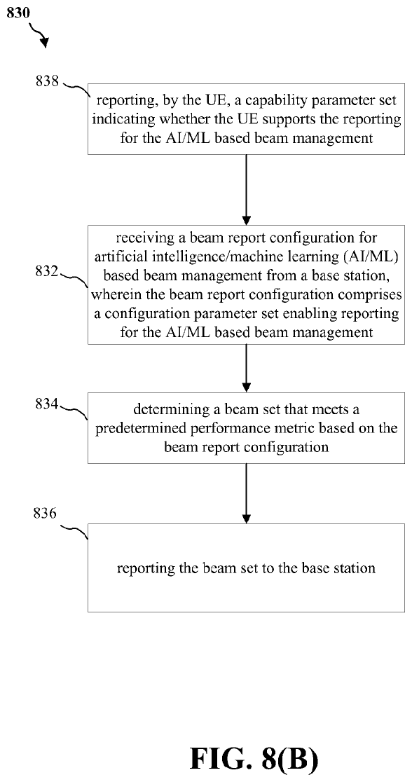

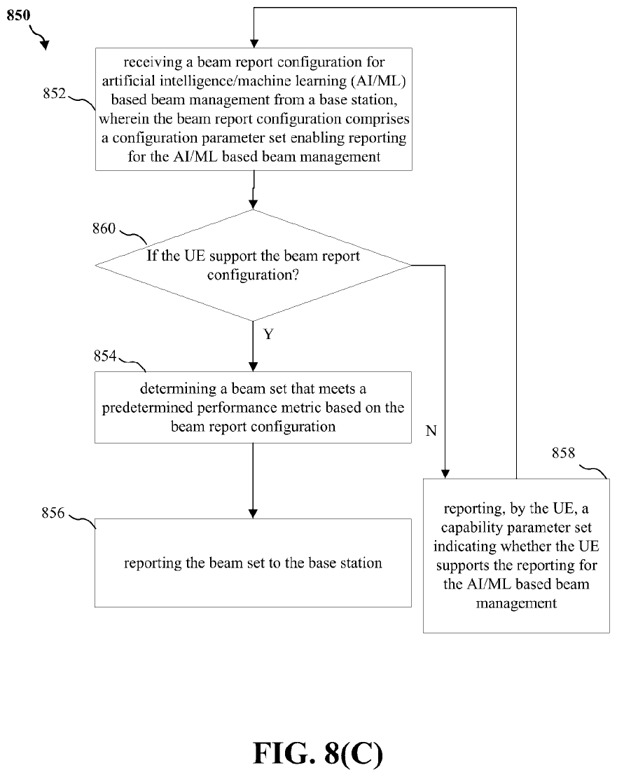

FIG. 8(A) illustrates a flow chart 800 of a process for beam reporting in an AI/ML-based beam management system. This process involves interactions between a network (NW) and a UE (e.g., the UE 704) through a base station (e.g., the base station 702).

At block 802, the NW determines a beam report configuration for AI/ML-based beam management. Then, the beam report configuration is communicated between the NW and the UE 704. For example, the UE 704 receives the configuration transmitted from the NW. This configuration may optimize the beam management process, as it defines the parameters and instructions that the UE 704 used for in its reporting tasks. The beam report configuration may encompass various aspects, including the number of beams to be reported, the types of measurements to be included in the report, the specific reporting format to be used, a configuration parameter set that enables reporting for AI/ML-based beam management. The configuration parameter set may include several elements as discussed in the previous sections. These may include the AI Beam Management (BM) modes (such as spatial beam prediction or temporal beam prediction), the measurement Rx type, parameters for UE-side model output reporting, parameters for network-side model input reporting, and parameters for data collection reporting.

At block 804, the UE 704 determines a beam set that meets a predetermined performance metric based on the beam report configuration. The UE 704 may determine a subset of beams (Set C) that meet the specified performance metrics. These metrics may include factors such as signal strength and reliability. The UE 704 may utilize measurements and/or AI/ML model inference on a set of sensing beams (Set B). At block 806, the UE 704 reports the beam set to the base station.

If the AI/ML model is at the UE side, it processes the measurements from Set B to predict the best beams in Set A. If the model is at the network side, the UE 704 reports the measurements of Set B, allowing the network to perform the prediction.

Once the subset of beams meeting the performance metrics is determined, the UE 704 reports these measurement results according to the received beam report configuration. This may involve reporting the predicted best beams, their corresponding RSRP values, or other specified metrics.

FIG. 8(B) presents a flow chart 830 that outlines another process for beam reporting, with an additional step focusing on UE capability reporting. Blocks 832, 834, and 836 of this process are similar to blocks 802, 804, and 806 of the process depicted in FIG. 8(A), respectively.

Further, at block 838, the UE 704 reports a capability parameter set. This set indicates whether the UE 704 supports the reporting for AI/ML-based beam management. The capability parameter set may include various elements that describe the UE's abilities in relation to AI/ML-based beam management. These may include, support for different AI BM modes (e.g., spatial or temporal beam prediction), supported Rx usage types, capabilities related to UE-side model output reporting (e.g., supported number of top-K beams to report), capabilities related to network-side model input reporting (e.g., supported data filtering methods), and capabilities related to data collection reporting (e.g., supported label sizes). In the embodiments as shown in FIG. 8(B), the UE 704 first reports its capability and then the NW determines a beam report configuration based on the capability report of the UE 704.

FIG. 8(C) presents a flow chart 850 that outlines a further process for beam reporting, with an additional step directed to UE capability reporting. Blocks 852, 854, 856 and 858 of this process are similar to blocks 832, 834, 836 and 838 of the process depicted in FIG. 8(B), respectively.

However, different from the embodiments as shown in FIG. 8(B), where block 838 occurs before block 832, in the embodiments as shown in FIG. 8(C), block 858 may occur after block 852. Following the receipt of the beam report configuration, at block 860, the UE 704 determines whether it supports the configuration. If yes, the UE performs its reporting duties based on the received configuration. Otherwise, the process proceeds to block 858 and then returns to block 852 for further action. That is, the NW initially determines a beam report configuration. If the UE 704 can support this configuration, it performs its reporting duties. If not, the UE 704 reports its capability to the NW, and the NW may then determine a new beam report configuration based on this capability report.

By reporting these capabilities, the UE 704 provides the network with information that allows for more efficient and effective beam management. The network can use this information to optimize its configurations and requests, aligning them with the specific capabilities of each UE.

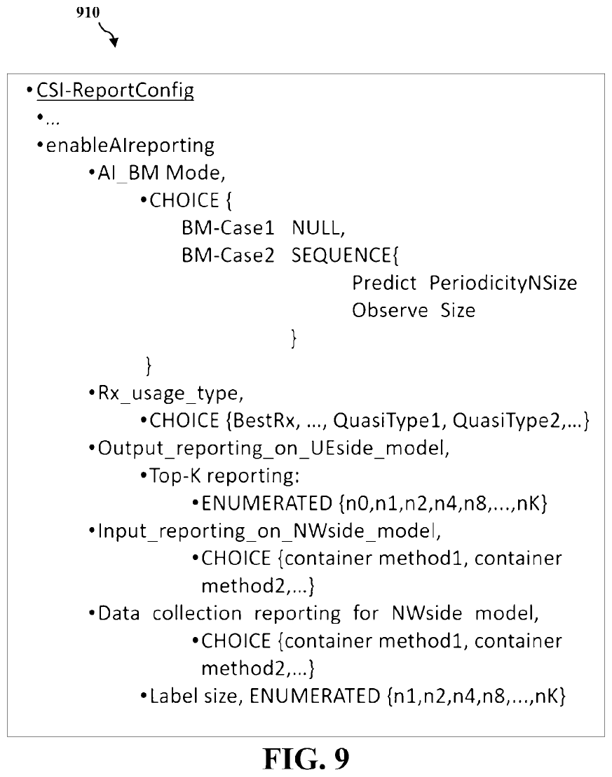

FIG. 9 illustrates a diagram 910 depicting a CSI report configuration structure, CSI-ReportConfig, according to the present disclosure. This configuration structure includes information elements (IEs), designed to support AI/ML-based beam management in advanced wireless communication systems.

The configuration structure includes an enableAIreporting IE, which serves as a flag to indicate whether AI reporting is enabled. When this IE is empty, the UE 704 assumes a legacy beam report is to be used.

An AI_BM Mode IE specifies the mode of AI/ML beam management for reporting. It offers two choices: BM-Case1 and BM-Case2. BM-Case1 corresponds to spatial beam prediction, where the UE 704 assumes the report is for spatial beam management. BM-Case2 relates to temporal beam prediction, where time information is included in the beam report. For BM-Case2, two sub-parameters are defined: Predict_PeriodicityNSize and Observe_Size. Predict_PeriodicityNSize indicates the number of predicting time instances and the periodicity of each time instance in the prediction window for model output. Observe_Size specifies the number of previous measurements on a set of beams for model input.

An Rx_usage_type IE is for reporting measurements of a set of beams for AI/ML beam management. When configured with this IE, the UE 704 assumes the measurements are derived by the configured Rx usage behavior. This IE addresses potential measurement issues that could affect the accuracy of the AI/ML model's predictions, particularly in scenarios where the UE 704 might select a suboptimal Rx beam direction.

An Output_reporting_on_UEside_model IE is used when the AI/ML model is located at the UE side. When the UE 704 is configured with this IE, it prepares information related to the predicted best beams in the beam report. This IE includes a sub-parameter called Top-K reporting, which indicates the possible number of predicted best beams for one predicted time instance. The values for Top-K reporting range from n0 to nK, where nk means the UE 704 reports the top K beams for one predicted time instance. The value no allows the UE 704 to adaptively choose the value of K for reporting. If BM-Case2 is configured, this value is applied to all the time instances indicated by Predict_PeriodicityNSize.

An Input_reporting_on_NWside_model IE is utilized when the AI/ML model is located at the network side. When configured with this IE, the UE 704 prepares measurements of the configured sets of RS resources in the beam report. The value choice for this IE indicates the type of report formats used for reporting the measurements. This IE represents a significant change from traditional reporting methods. In conventional systems, when the network configures a set of RS resources (e.g., 24 beams) for the UE 704 to measure, the UE 704 typically reports only the top four best RSRP measurements. However, with AI/ML-based beam management, when the network configures a set of RS resources (e.g., 4 or 8 beams, depending on the size of Set B), the UE 704 is expected to report all the measurements it obtained, as specified by the network's configuration.

An Data_collection_reporting IE is used for data collection purposes, which is for AI/ML model training. When the UE 704 is configured with this IE, it prepares two types of information in the beam report: measurements of a first set of RS resources and indicators of the measured best beams among a second set of RS resources. The value choice for this IE indicates the type of report formats used for reporting both the measurements and indicators. This IE includes a sub-parameter called Label size, which indicates the number of best beam indicators of the second set of RS resources that the UE 704 includes in the beam report for each time instance.

These new IEs provide a flexible and comprehensive framework for configuring AI/ML-based beam management reporting. They allow the network to specify detailed requirements for beam reporting, accommodating various scenarios such as UE-side models, network-side models, and data collection for model training. By introducing these parameters, the system can leverage the power of AI/ML techniques in beam management while maintaining the flexibility to adapt to different network configurations and UE capabilities.

The introduction of these new IEs addresses the limitations of traditional beam reporting methods, particularly in the context of AI/ML-based beam management. They enable more efficient and targeted reporting, allowing for better utilization of network resources and potentially improving overall system performance in 5G and beyond wireless communication systems.

In a first example of utilizing the CSI report configuration structure, the network (NW) can configure the UE 704 to report the Top-K predicted best beams from a UE-side model for Beam Management (BM) Case1. This example illustrates the practical application of the AI/ML-based beam management reporting configuration discussed above.

The NW, through the base station 702, configures two parameters in the CSI report configuration: “AI_BM Mode” and “Output_reporting_on_UEside_model”. These parameters instruct the UE 704 on how to perform and report its beam predictions.

For the “AI_BM Mode” parameter, the NW may configure it to BM-Case1, indicating spatial beam prediction. This configuration tells the UE 704 that it should perform spatial beam prediction rather than temporal beam prediction. In spatial beam prediction, the UE 704 predicts the best beams based on the current spatial distribution of signal strengths, without considering time-series data.

Alternatively, if temporal aspects need to be considered, the NW may configure BM-Case2. In such a case, additional sub-parameters would be set, such as Predict_PeriodicityNSize and Observe_Size. For instance, these could be set to 1, indicating a single prediction instance and a single observation instance.

The “Output_reporting_on_UEside_model” parameter is configured to specify the Top-K reporting. This parameter includes a sub-parameter that determines how many top beams the UE 704 should report. In this example, the NW configures this value to n4, instructing the UE 704 to report the Top-4 predicted best beams. The content of this reporting is further specified in the IE reportQuantity, which may include details such as beam identifiers and predicted RSRP values.

After receiving this configuration, when the UE 704 is triggered to generate a report, it follows a specific process. First, the UE 704 measures the configured RS resource sets, which correspond to Set B in the AI/ML model. These measurements may be performed in real-time or, to reduce processing overhead, the UE 704 may use recent previous measurements if available.

Next, the UE 704 applies its UE-side AI/ML model to these measurements. This model, which has been trained on historical data, processes the input from Set B to infer the Top-4 predicted best beams. The model considers various factors such as signal strength patterns and historical performance to make these predictions.

Finally, the UE 704 compiles a report based on the model's output and the configuration parameters. This report includes the resource indicators (beam IDs) for the Top-4 predicted best beams. If the UE's AI model is capable of predicting RSRP values (which depends on the specific model implementation), the UE 704 will also include these predicted RSRP values in the report. The UE 704 then transmits this report back to the NW via the base station 702.

This example demonstrates how the new CSI report configuration structure enables more efficient beam management. By allowing the UE 704 to report only the top predicted beams based on its AI/ML model, rather than exhaustive measurements, the system reduces signaling overhead while still providing the network with crucial information for optimizing communication. This approach uses the UE's local processing capabilities and its ability to quickly adapt to changing signal conditions, potentially leading to improved overall system performance in 5G and beyond wireless communication systems.

In a second example of utilizing the CSI report configuration structure, the network (NW) can configure the UE 704 to report the Top-K predicted best beams from a UE-side model for Beam Management (BM) Case2. This example illustrates the application of AI/ML-based beam management reporting configuration for temporal beam prediction.

The NW, through the base station 702, configures two primary parameters in the CSI report configuration: “AI_BM Mode” and “Output_reporting_on_UEside_model”. These parameters instruct the UE 704 on how to perform and report its beam predictions, specifically for temporal beam prediction.

For the “AI_BM Mode” parameter, the NW configures it to BM-Case2, indicating temporal beam prediction. This configuration tells the UE 704 that it should perform temporal beam prediction, considering time-series data in its predictions. In temporal beam prediction, the UE 704 predicts the best beams based not only on the current spatial distribution of signal strengths but also on how these signal strengths have changed over time.

When configuring BM-Case2, the NW also sets two important sub-parameters: Predict_PeriodicityNSize and Observe_Size. In this example, Predict_PeriodicityNSize is set to {20 ms, size=2}. This means that the UE 704 is instructed to make predictions for two future time slots, with each slot having a periodicity of 20 milliseconds. The Observe_Size is set to 4, indicating that the UE 704 should use measurements from four previous time periods as input for its prediction model.

The “Output_reporting_on_UEside_model” parameter is configured to specify the Top-K reporting. In this example, the NW configures this value to n1, instructing the UE 704 to report the Top-1 predicted best beam for each prediction time slot. The content of this reporting is further specified in the IE reportQuantity, which may include details such as beam identifiers and predicted RSRP values.

After receiving this configuration, when the UE 704 is triggered to generate a report, it follows a specific process. First, the UE 704 measures the configured RS resource sets, which correspond to Set B in the AI/ML model, over four time periods as specified by the Observe_Size parameter. These measurements may be performed in real-time or, to reduce processing overhead, the UE 704 may use recent previous measurements if available.

Next, the UE 704 applies its UE-side AI/ML model to these measurements. This model, which has been trained on historical time-series data, processes the input from Set B to infer the Top-1 predicted best beam for each of the two future time slots. The model considers various factors such as signal strength patterns, historical performance, and temporal trends to make these predictions.

Finally, the UE 704 compiles a report based on the model's output and the configuration parameters. This report includes the resource indicators (beam IDs) for the Top-1 predicted best beam for each of the two future time slots, each 20 ms apart. If the UE's AI model is capable of predicting RSRP values (which depends on the specific model implementation), the UE 704 will also include these predicted RSRP values in the report for each predicted time slot.

This example demonstrates the flexibility and power of the new CSI report configuration structure in supporting advanced AI/ML-based beam management techniques. By allowing the UE 704 to report predictions for future time slots based on temporal patterns, the system can potentially anticipate and adapt to changing signal conditions more effectively than traditional methods. This approach uses the UE's local processing capabilities and its ability to learn from historical data, potentially leading to improved overall system performance and more efficient resource utilization in 5G and beyond wireless communication systems.

In a third example of utilizing the CSI report configuration structure, the network (NW) configures the UE 704 to report measurements that will be used as input for the NW-side AI/ML model. In this scenario, the base station 702 configures several key parameters in the CSI report configuration: “AI_BM Mode”, “Rx_usage_type”, and “Input_reporting_on_NWside_model”. These parameters instruct the UE 704 on how to perform measurements and report them for the NW-side model inference.

For the “AI_BM Mode” parameter, the base station 702 configures it to BM-Case1, indicating spatial beam prediction. This configuration tells the UE 704 that it should perform spatial beam prediction rather than temporal beam prediction. In spatial beam prediction, the UE 704 reports measurements based on the current spatial distribution of signal strengths, without considering time-series data.

The “Rx_usage_type” parameter is set to “BestRx”. This configuration is crucial as it defines how the UE 704 should perform its measurements. When set to “BestRx”, for each Tx beam of the model input, the UE 704 will conduct multiple measurements using different Rx beams. It will then determine the best measurement among these and include this best measurement in the measurement report. This approach aims to provide the most accurate signal strength information for each Tx beam, which is essential for the NW-side AI/ML model to make accurate predictions.

The “Input_reporting_on_NWside_model” parameter is configured to specify the reporting method. If the UE 704 is configured with a specific container, it will use the corresponding container method (report format) to report the measurements. This parameter allows flexibility in how the measurements are reported, which can be tailored to the specific requirements of the NW-side AI/ML model.

After receiving this configuration and being triggered to generate a report, the UE 704 follows a specific process. First, it measures the configured RS resource sets, which correspond to Set B in the AI/ML model. These measurements are performed using Rx beam sweeping, as specified by the “BestRx” configuration. This means that for each Tx beam in Set B, the UE 704 will try multiple Rx beams and select the best measurement.

If recent previous measurements of the configured RS resource sets are available and still valid, the UE 704 may use these to reduce processing overhead. This approach can be particularly useful in scenarios where channel conditions are relatively stable over short periods.

Finally, the UE 704 compiles a report based on these measurements and the configuration parameters. For each configured RS resource (Tx beam) in Set B, the UE 704 reports the best measured RSRP to the base station 702. This report follows the specified report format as configured in the “Input_reporting_on_NWside_model” parameter.

In a fourth example of utilizing the CSI report configuration structure, the network (NW) configures parameters for NW-side data collection for Beam Management (BM) Case1. This example demonstrates how the new CSI report configuration can be used to collect data for training and improving AI/ML models at the network side.

The base station 702 configures several key parameters in the CSI report configuration: “AI_BM Mode”, “Rx_usage_type”, and “Data_collection_reporting_for_NWside_model”. These parameters instruct the UE 704 on how to perform measurements and report them for data collection purposes.

For the “AI_BM Mode” parameter, the base station 702 configures it to BM-Case1, indicating spatial beam prediction. This configuration tells the UE 704 that it should perform spatial beam prediction rather than temporal beam prediction. In spatial beam prediction, the UE 704 reports measurements based on the current spatial distribution of signal strengths, without considering time-series data.

The “Rx_usage_type” parameter is set to “QuasiType1”. This configuration is crucial as it defines how the UE 704 should perform its measurements. When set to “QuasiType1”, for each Tx beam of the model input, the UE 704 will conduct one measurement using the best Rx beam derived from the previous measurement and include the corresponding measurement in the report. This approach aims to balance measurement accuracy with efficiency, as it uses information from previous measurements to guide the current measurement process.

The “Data_collection_reporting_for_NWside_model” parameter is configured to specify the reporting method and label size. If the UE 704 is configured with a specific container, it will use the corresponding container method (report format) to report the measurements. This parameter allows flexibility in how the measurements are reported, which can be tailored to the specific requirements of the NW-side AI/ML model training process.

Additionally, the base station 702 configures the Label size parameter. In this example, it is set to n8, which means that for each slot of the prediction window, the UE 704 should include the indicators of the best 8 beams in the report. This configuration is particularly important for data collection, as it provides the ground truth labels necessary for training the AI/ML model.

After receiving this configuration and being triggered to generate a report, the UE 704 follows a specific process. First, it measures the configured first set of RS resources (corresponding to Set B) using the Rx beam that was previously used as the receiving Rx. This measurement provides the input data for the AI/ML model.

Next, the UE 704 measures the configured second set of RS resources (corresponding to Set A), also using the Rx beam that was previously used as the receiving Rx. After these measurements, the UE 704 derives the indicators of the Top-8 beams from the second set of RS resources by comparing the measurements. This step provides the ground truth labels for the AI/ML model training.

Finally, the UE 704 compiles a report that includes two types of information: the measurements of the first set (Set B) and the indicators of the Top-8 beams from the second set (Set A). This report is sent to the base station 702 using the specified container method.

Further, there is a need for establishing a framework for UE capability reporting. This framework allows the UE 704 to inform the base station 702 about its specific capabilities related to AI/ML-based beam management features. By providing this information, the network can optimize its configurations and requests, aligning them with the specific capabilities of each UE.

The UE capability reporting for AI/ML-based beam management includes several feature indicators and their corresponding components as listed in Table 1 below.

TABLE 1
List of features and components in UE capability

| Feature | Components |
|---|---|
| AI reporting: | (1) Support AI reporting |
| feature in UE capability to | |
| indicates whether UE supports | |
| reporting for AI/ML-based | |
| beam management | |
| AI-BM Mode: | (1) Supported AI BM modes: |
| feature in UE capability to | (I) indicate the supported prediction slot periodicities of UE's |
| indicates which AI/ML beam | BM Case2 AI/ML models |
| management use cases UE | (II) how many prediction slots are supported by UE's BM Case2 |
| supports | AI/ML models |
| Rx usage type: | (1) Supported Rx usage types |
| feature in UE capability to | |
| indicates which Rx beam | |
| assumption that UE supports | |
| Output reporting on UE-side | (1) Support Output reporting on UE-side model: |
| model: | indicate whether UE support Output reporting on UE-side model |
| feature in UE capability to | (2) Top-K reporting: |
| define the support of reporting | indicate UE supports how many beams are reported as UE side |
| the output of UE side AI/ML | AI/ML model output |
| model for AI/ML-based Beam | (3) Report contents: |
| Management | indicate UE supports which contents that are reported as UE side |
| | AI/ML model output |
| | (4) Report container methods: |
| | indicate the beam report formats that UE supports for |
| | measurement reporting |
| Input reporting on NW-side | (1) Support Input reporting on NW-side model: |
| model: | indicate whether UE support input reporting on NW-side model |
| feature in UE capability to | (2) Data filtering methods: |
| indicate whether UE supports | indicate the methods that UE supports to filter the measurement |
| reporting for the input of NW | data for reporting |
| side AI/ML model for AI/ML- | (3) Report container methods: |
| based Beam Management | indicate the beam report formats that UE supports for |
| | measurement reporting |
| Data collection reporting for AI | (1) Support Data collection reporting for NW-side model: |
| BM: | indicate whether UE support data collection reporting for AI BM |
| feature in UE capability to | (2) Data filtering methods: |
| indicate whether UE supports | indicate the methods that UE supports to filter the measurement |
| reporting for the data collection | data for reporting |
| for AI/ML model for AI/ML- | (3) Report container methods: |
| based Beam Management | indicate the beam report formats that UE supports for |
| | measurement reporting |
| | (4) Label sizes: |
| | indicate the number of labels that UE supports for reporting as |
| | ground truth model output |

An AI Reporting indicator indicates whether the UE 704 supports reporting for AI/ML-based beam management. The UE 704 reports a boolean value (True/False) to indicate its capability. This allows the network to determine if the UE 704 can participate in AI/ML-based beam management processes.

An AI BM Mode indicator indicates which AI/ML beam management use cases the UE 704 supports. The UE 704 reports a sequence of supported modes, which may include BM-Case1 (spatial beam prediction) and BM-Case2 (temporal beam prediction). For BM-Case2, the UE 704 also reports supported UE-side model prediction periodicities (e.g., 20 ms, 40 ms) and supported number of future predicted time slots (e.g., 1, 2). This detailed reporting allows the network to understand the temporal prediction capabilities of the UE 704, enabling more efficient configuration of temporal beam prediction tasks.

An Rx Usage Type indicator indicates which Rx beam assumptions the UE 704 supports for measuring signals configured by the network. The UE 704 reports a sequence of supported Rx usage types. The supported Rx usage types may include BestRx. The UE 704 sweeps all available Rx beams and uses the best measurement. The supported Rx usage types may include QuasiRxType1. The UE 704 finds the best Rx beam for a specific configured signal, then uses this beam for other signals. The supported Rx usage types may include QuasiRxType1. The UE 704 uses the previously best Rx beam for measurements. This information allows the network to understand how the UE 704 performs measurements, which is crucial for the accuracy of AI/ML model inputs and predictions. The UE 704 may also send indicators indicate other possible Rx beam assumptions.

UE-side model output reporting allows a UE 704 to report the output of its AI/ML model to the base station 702, providing information for optimizing beam selection and overall network performance.

The capability of UE-side model output reporting is signaled through several parameters:
1. Support Output reporting on UE-side model: This is a binary indicator (Yes/No) that informs the base station 702 whether the UE 704 can perform AI/ML-based beam prediction and reporting. If the UE 704 has not implemented any AI/ML model, it reports that it does not support this feature.
2. Top-K reporting: This parameter indicates the number of top beams the UE 704 can report as its AI/ML model output. It is represented as a sequence of enumerated values (n0, n1, n2, n3, n4, . . . , nK), where each value corresponds to a specific number of beams. The special value n0 allows the UE 704 to adaptively decide how many beams to report at each reporting instance, providing flexibility in varying channel conditions. Furthermore, the parameter may define two scenarios: (1) the UE 704 reports a number, indicating that it only supports reporting this specific number of beams; and (2) the UE 704 reports a number, indicating that it supports reporting any number of beams that is less than or equal to the reported number.
3. Report contents: This parameter specifies the types of information the UE 704 can include in its AI/ML model output. The options include:
   Predicted_best_beam_IDs: The identifiers of the predicted best beams.
   Predicted_best_beam_RSRPs: The predicted Reference Signal Received Power (RSRP) values for the best beams.
   Predicted_best_beam_SINRs: The predicted Signal-to-Interference-plus-Noise Ratio (SINR) values for the best beams.
   This allows the UE 704 to report not just the beam identifiers but also the expected signal quality, enabling more informed decision-making at the base station 702.
4. Report container methods: This parameter indicates the beam report formats that the UE 704 supports for measurement reporting. The options include:
   Container_method1 (legacy container): The current beam report format.
   Container_method2 (beam_report_without_RI): The current format but only reporting signal strength measurements (RSRP/RSRQ/SINR) without reporting the CRI/SSBRI.
   Container_method3 (two_part_CSI_beam_report): A format that separates the beam report into two parts, similar to the two-part CSI for reporting PMI.
   Container_method4 (time_info_attached): A format that attaches time information to the legacy beam report.

The flexibility in report container methods allows for efficient reporting tailored to different network configurations and requirements. For instance, the two-part CSI beam report might be beneficial in scenarios where the network needs to process beam information in stages, while the time-info-attached format could be crucial for temporal beam prediction in BM-Case2 scenarios.

By reporting these capabilities, the UE 704 provides the base station 702 with a comprehensive understanding of its AI/ML-based beam prediction abilities. This information allows the base station 702 to optimize its configuration requests, aligning them with the specific capabilities of each UE 704 in the network.

For example, if a UE 704 reports that it can predict both beam IDs and RSRPs for the top 4 beams, the base station 702 can configure it to report this information. This detailed prediction can help the base station 702 make more informed decisions about beam selection and resource allocation, potentially improving overall network performance.

Moreover, the ability for the UE 704 to adaptively decide how many beams to report (n0 in Top-K reporting) can be useful in dynamic environments. In scenarios with rapidly changing channel conditions, the UE 704 might adjust the number of reported beams based on the current channel state, reporting more beams when the channel is complex and fewer when it's stable.

The capability of input reporting on the network-side model allows the UE 704 to report measurements that serve as input for the AI/ML model located at the network side, typically at the base station 702.

The UE 704 reports its capability for input reporting on the network-side model through several parameters:
1. Support input reporting on NW-side model: This is a binary indicator (Yes/No) that informs the base station 702 whether the UE 704 can perform and report measurements suitable for input to the network-side AI/ML model.
2. Data filtering methods: This parameter indicates the methods that the UE 704 supports for filtering measurement data before reporting. The supported methods may include:
   No_filter: The UE 704 reports all measurements without filtering.
   Filter_15dB_belowthebest: The UE 704 only reports measurements with signal strength higher than (the best measured signal strength-15 dB).
   Filter_10dB_belowthebest: The UE 704 only reports measurements with signal strength higher than (the best measured signal strength-10 dB).
   Filter_best4: The UE 704 only reports the top 4 measurements with the best signal strength.
   Filter_best8: The UE 704 only reports the top 8 measurements with the best signal strength.
3. Report container methods: This parameter specifies the beam report formats that the UE 704 supports for measurement reporting. The options may include:
   Container_method1 (legacy container): The current beam report format.
   Container_method2 (beam_report_without_RI): The current format but only reporting signal strength measurements (RSRP/RSRQ/SINR) without reporting the CRI/SSBRI.
   Container_method3 (two_part_CSI_beam_report): A format that separates the beam report into two parts, similar to the two-part CSI for reporting PMI.
   Container_method4 (time_info_attached): A format that attaches time information to the legacy beam report.

Data filtering may reduce the uplink control information (UCI) overhead. In scenarios where the network-side AI/ML model may not require very low L1 RSRP measurements, the base station 702 can instruct the UE 704 to omit reporting these low measurements. This filtering can reduce the amount of data the UE 704 needs to report, thereby decreasing UCI overhead.

For example, if the base station 702 configures the UE 704 to use the Filter_15dB_belowthebest method, the UE 704 will only report measurements that are within 15 dB of the strongest measured signal. This approach can effectively eliminate weak signals that are unlikely to be useful for the AI/ML model, while still providing a comprehensive view of the stronger signals in the environment.

The flexibility in report container methods allows for efficient reporting tailored to different network configurations and requirements. For instance, the two-part CSI beam report might be beneficial in scenarios where the network needs to process beam information in stages, while the time-info-attached format could be crucial for temporal beam prediction in BM-Case2 scenarios.

The capability of data collection reporting for AI/ML-based Beam Management allows the UE 704 to report measurements and ground truth data that can be used for training and improving AI/ML models at the network side. This feature is crucial for the continuous enhancement of AI/ML-based beam management systems.

The UE 704 reports its capability for data collection reporting through several parameters:
1. Support data collection reporting for AI BM: This is a binary indicator (Yes/No) that informs the base station 702 whether the UE 704 can perform and report measurements suitable for data collection purposes in AI/ML-based Beam Management.
2. Data filtering methods: This parameter indicates the methods that the UE 704 supports for filtering measurement data before reporting. The supported methods may include:
   No_filter: The UE 704 reports all measurements without filtering.
   Filter_15dB_belowthebest: The UE 704 only reports measurements with signal strength higher than (the best measured signal strength-15 dB).
   Filter_10dB_belowthebest: The UE 704 only reports measurements with signal strength higher than (the best measured signal strength-10 dB).
   Filter_best4: The UE 704 only reports the top 4 measurements with the best signal strength.
   Filter_best8: The UE 704 only reports the top 8 measurements with the best signal strength.

These filtering methods can help reduce the uplink control information (UCI) overhead by limiting the amount of data reported, while still providing valuable information for model training.
3. Report container methods: This parameter specifies the beam report formats that the UE 704 supports for measurement reporting. The options may include:
   Container_method1 (legacy container): The current beam report format.
   Container_method2 (beam_report_without_RI): The current format but only reporting signal strength measurements (RSRP/RSRQ/SINR) without reporting the CRI/SSBRI.
   Container_method3 (two_part_CSI_beam_report): A format that separates the beam report into two parts, similar to the two-part CSI for reporting PMI.
   Container_method4 (time_info_attached): A format that attaches time information to the legacy beam report.
   These different report container methods provide flexibility in how the data is reported, allowing for efficient transmission of information tailored to different network configurations and AI/ML model requirements.
4. Label sizes: This parameter indicates the number of labels (ground truth for model output) that the UE 704 supports for reporting. It is represented as a sequence of enumerated values (n1, n2, n3, n4, . . . , nK), where each value corresponds to a specific number of labels the UE 704 can report.

The data collection reporting capability allows the network to gather real-world data for training and refining its models. When configured for data collection, the UE 704 reports two types of information: 1. Measurements of a first set of RS resources (corresponding to Set B), which serve as input features for the AI/ML model. 2. Indicators of the measured best beams among a second set of RS resources (corresponding to Set A), which serve as ground truth labels for the AI/ML model.

For example, if the base station 702 configures the UE 704 with a label size of n8, the UE 704 will report the indicators of the best 8 beams from Set A for each reporting instance. This provides a rich set of ground truth data for training the AI/ML model.

The flexibility in data filtering methods and report container methods allows the network to balance between the quantity and quality of collected data and the associated UCI overhead. For instance, using the Filter_15dB_belowthebest method can help focus on the most significant measurements while reducing the amount of data transmitted.

The collected data can be used to train new models, fine-tune existing ones, and validate the performance of AI/ML algorithms in real-world scenarios. This capability contributes to the overall enhancement of beam management in 5G and beyond wireless communication systems, potentially leading to improved spectral efficiency and user experience.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a UE, comprising:
receiving a beam report configuration for artificial intelligence/machine learning (AI/ML) based beam management from a base station, wherein the beam report configuration comprises a configuration parameter set enabling reporting for the AI/ML based beam management;
determining a beam set that meets a predetermined performance metric based on the beam report configuration; and
reporting the beam set to the base station.

2. The method of claim 1, wherein the configuration parameter set comprises a mode parameter indicating spatial beam prediction or temporal beam prediction.

3. The method of claim 2, wherein when the mode parameter indicates temporal beam prediction, the configuration parameter set further comprises:
a parameter indicating a periodicity of prediction time instances and a number of the prediction time instances; and
a parameter indicating a number of observation time instances.

4. The method of claim 1, wherein the configuration parameter set comprises a receive (Rx) usage type parameter indicating an Rx usage type for measurement.

5. The method of claim 1, wherein the configuration parameter set comprises a model output parameter indicating the reporting for the AI/ML based beam management is for inferred model output reporting for a UE side AI/ML model.

6. The method of claim 5, wherein the model output parameter comprises a parameter indicating a number of inferred beams to report.

7. The method of claim 1, wherein the configuration parameter set comprises a model input parameter indicating the reporting for the AI/ML based beam management is for AI/ML model input for a network (NW) side model.

8. The method of claim 7, wherein the model input parameter comprises a parameter indicating a reporting format.

9. The method of claim 1, wherein the configuration parameter set comprises a data collection parameter indicating the reporting for the AI/ML based beam management is for data collection.

10. The method of claim 9, wherein the data collection parameter comprises a parameter indicating a reporting format and a parameter indicating a label size.

11. The method of claim 1, further comprising:
reporting a capability parameter set to the base station, wherein the capability parameter set indicates whether the UE supports the reporting for the AI/ML based beam management.

12. The method of claim 11, wherein the capability parameter set comprises a mode feature indicating which AI/ML based beam management use cases the UE supports.

13. The method of claim 12, wherein when the mode feature indicates the UE supports temporal beam prediction, the capability parameter set further comprises:
a component indicating a periodicity of prediction slots and a number of the prediction slots supported by the UE.

14. The method of claim 11, wherein the capability parameter set comprises a receive (Rx) usage type feature indicating which Rx beam assumption the UE supports.

15. The method of claim 11, wherein the capability parameter set comprises an output reporting feature defining support of model output reporting for a UE side AI/ML model.

16. The method of claim 15, wherein the output reporting feature comprises:
a component indicating whether the UE supports the model output reporting for the UE side AI/ML model;
a component indicating a number of beams or a maximum number of beams the UE supports reporting as an output of the UE side AI/ML model;
a component indicating contents that the UE supports reporting as the output of the UE side AI/ML model; and
a component indicating beam report formats that the UE supports for the reporting for the AI/ML based beam management.

17. The method of claim 11, wherein the capability parameter set comprises an input reporting feature indicating whether the UE supports model input reporting for a NW side AI/ML model.

18. The method of claim 17, wherein the input reporting feature comprises:
a component indicating whether the UE supports the model input reporting for the NW side AI/ML model;
a component indicating data filtering methods that the UE supports to filter measurement data for reporting; and
a component indicating beam report formats that the UE supports for measurement reporting.

19. The method of claim 11, wherein the capability parameter set comprises a data collection reporting feature indicating whether the UE supports reporting for data collection for an AI/ML model for the AI/ML based beam management.

20. The method of claim 19, wherein the data collection reporting feature comprises:
a component indicating whether the UE supports data collection reporting;
a component indicating data filtering methods that the UE supports to filter measurement data for reporting;
a component indicating beam report formats that the UE supports for measurement reporting; and
a component indicating a number of labels that the UE supports for reporting as a ground truth model output.
